(19) United States
(12) Patent Application Publication
(10) Pub. No.: US 2024/0281457 A1
(43) Pub. Date: Aug. 22, 2024

(54) COMPUTERIZED METHOD AND SYSTEM FOR DYNAMIC ENGINE PROMPT GENERATION

(71) Applicant: Highlight US Inc., Lewes, DE (US)

(72) Inventors: Wilhelmus de Witte, New York, NY (US); Karthick Jeyapal, Bangalore (IN); Umut YILDIRIM, Istanbul (TR)

(21) Appl. No.: 18/649,681

(22) Filed: Apr. 29, 2024

Related U.S. Application Data
(63) Continuation-in-part of application No. 17/506,787, filed on Oct. 21, 2021.
Application No. 17/506,787 is a continuation-in-part of application No. 17/117,208, filed on Dec. 10, 2020, now Pat. No. 11,188,760.
(60) Provisional application No. 62/946,360, filed on Dec. 10, 2019.
(60) Provisional application No. 63/551,994, filed on Feb. 9, 2024.
(60) Provisional application No. 63/552,124, filed on Feb. 10, 2024.

(51) Int. Cl. G06F 16/33; G06F 16/335

(52) U.S. Cl. CPC G06F 16/3347; G06F 16/335

(57) ABSTRACT

A computerized method providing for generating a predicted intent usable for generating a prompt for an artificial intelligence engine, as well as other computing resources. The method includes capturing user interactions on a computing device and storing user interaction data. The method includes accessing at least one data storage device having user interaction data therein. The user interaction data can be stored via vector modeling. The method includes analyzing the user interaction data and generating a user context therefrom. Therefrom, the method includes generating a predicted intent within a user display interface, the predicted intent generated from the user context.

### RELATED APPLICATIONS

The present application a continuation-in-part of and claims priority to U.S. patent application Ser. No. 17/506,787 filed Oct. 21, 2021, which is a continuation-in-part of and claims priority to U.S. patent application Ser. No. 17/117,208, now issued U.S. Pat. No. 11,188,760, filed Dec. 10, 2020, which claims priority to U.S. Provisional Patent App. Ser. No. 62/946,360 filed Dec. 10, 2019.

The present application is a non-provisional application of and claims priority to U.S. Provisional Application No. 63/551,994 filed Feb. 9, 2024 and U.S. Provisional Application No. 63/552,124 filed Feb. 10, 2024.

### FIELD OF INVENTION

The present invention relates generally to computer processing and executable operations for tracking user activity and more specifically to dynamic generation of computer engine prompts based on the tracked user activity.

### BACKGROUND

A core factor for maximizing the benefits of Al engines is generating useful and meaningful prompts. There are inherent challenges users face when crafting effective prompts. Often times, hurdles lie in the conceptual gap between the user's intent and the Al model's capabilities.

Firstly, users often lack a deep understanding of the inner workings of these models. Unlike humans who can adapt their communication based on context, users struggle to translate their desired outcome into the specific language and format understood by the Al engine. This can lead to mismatched expectations and ultimately, irrelevant or nonsensical outputs.

Secondly, users themselves may hold unconscious biases that can unintentionally influence their prompts. These biases, stemming from personal experiences or societal norms, can be subtly woven into the wording and structure of the prompt. As Al models rely heavily on the data they are trained on, these biases can be reflected in the generated outputs, potentially perpetuating harmful stereotypes or generating factually incorrect information.

An immediate challenge lies in empowering users to effectively interact with these powerful tools. Currently, prompt techniques involve users manually submitting a written input, similar to techniques used with search engines. This creates a technical choke point where the effectiveness of engine results are directly correlated to the quality of the prompt.

Chatbots are an example of an Al-engine based support tool. For example, Copilot available from Microsoft is a support tool operating with various applications, using user prompts as input, contextual graphing functions based on system-wide data, and a large language model (LLM) to generate a response. Like other support tools, the effectiveness of a response is predicated on the accuracy of the input prompt.

Previously, LLMs acting as a form of artificial intelligence foundation had to be housed in a networked environment due to the data size. Only recently have improvements in LLM processing operations made local models for analysis available in a desktop or local processing environment. The current solution described herein was not even a viable processing technique until LLM and related processing operations became available in a localized processing environment.

There are limited techniques for prompt engineering. Current approaches typically involve trial and error. Moreover, current prompt engineering and engine engagements require a direct engagement and re-active to user input. This existing technique requires a user to actively seek out an AI engine engagement portal, generate the prompt, and interact with the engine output and/or revise the prompt.

There are no existing techniques that dynamically generate AI prompt techniques based on tracking user interactions and/or user activities.

### BRIEF DESCRIPTION

The present method and system provides for generating an engine prompt using collected data relating to user interactions. A user is on his or her computer performing normal computing interactions. Via the present method and system, the user can acquire a snapshot of the user's context over a prior period of time. Based on this snapshot, prompts can be generated and made available for engine execution.

The engine prompt can be for any suitable type of engine, including but not limited to an artificial intelligence engine. The term prompt, as used herein, represents any suitable input or other engagement operation usable with one or more engines. A prompt can be a text-based input, for example a text input inquiry submittable to an AI engine. A prompt can be an instruction for one or more utility applications, for example of an instruction to set a calendar reminder. The present examples are general examples and not limiting in nature.

The method and system is executable via software executable instructions performed by one or more processing devices. The method and system includes local processing operations, but can also include processing operations and/or accessing data sets external to the local processing environment.

As part hereof, the method and system includes tracking or otherwise monitoring user interactions. These interactions can include any type of engagement with the processing environment, including but not limited to, capturing user audio input, capturing user video input, capturing application execution, input, and outputs, and in one embodiment capturing screen grabs or other video captures of the user interactions.

The user interaction capture can be a background execution, storing the interaction data in a local memory device or cache. For example, one embodiment may include a limited time of background capture to save memory and address user security concerns. In another embodiment, the user interaction capture can be a user-requested event or tied to a particular application. For example, the background capture may be inactive for a user watching a movie or reading emails. By contrast, the background capture may be activated by the user launching a coding writing application, a videoconferencing application, etc.

In one embodiment, the method and system includes an intent detection request. This request can be dynamically generated by the processing system or can be in response to a user request. For example, a user request can include launching an application such as a coding application, a videoconferencing application, a web browser or searching application, etc. In another example, the user request can be detected or estimated based on user interactions, including in one embodiment proposing or suggesting a request for intent detection to the user.

When an intent detection request is received or acknowledged, the method and system includes accessing at least one data storage device having user interaction data associated with the user's interactions with the computing device.

In one embodiment, the device can be a locally-stored cache of user interaction data. In another embodiment, the cache can be distributed across a network storage or other remote storage embodiments and is not expressly limited to a local storage.

The user interaction data includes any data indicating user interactions.

The method and system includes processing operations for analyzing the user interaction data and generating a user context therefrom. For example, the processing operations can detect text and/or audio input and use language recognition and pattern detections to determine various words and phrases. For these words and phrases, processing operations can estimate a context. In one example, the processing operations can use image capture or image processing routines to detect or estimate images on the user display. From these images, processing operations can estimate a context.

Having generated a user context, the method and system therein generates a predicted intent. The predicted intent is a representation of the computer-generated user context. In one embodiment, the predicted intent is generated by accessing one or more LLMs, such as but not expressly limited to a locally-stored LLM.

This predicted intent can be represented in any number of suitable formats. For example, one exemplary format can be a pop-up window on the display monitor stating the predicted intent and asking the user to address the accuracy of this predicted intent, e.g. providing direct user feedback.

For example, one exemplary format be a window or display including multiple formats or versions of the predicted intent as a prompt statement available to various computer engines. Users can interact with the window, including selecting one or more engines for submitting the prompt, or modifying the prompt statement.

In further embodiments, the method and system allows for direct access to one or more computer engines using the prompts generated based the predicted intent. For example, computer engines may be any suitable executable application(s) and/or processing system(s) as noted herein. Engines can include machine learning or higher order processing functionality. For example, one type of engine can be an artificial intelligence engine, such as a commercially available, publicly available, or proprietary engine(s). For example, other types of engines can be utility applications, e.g. calendar application, messenger application, texting application, etc. For example, other types of engines can be web-based portals, such as a data repositories such as online “wiki” locations, online discussion forums, etc. For example, other types of engines can be software drafting or coding assistance programs. The engines listed herein are exemplary in nature and not expressly limiting of types of engines the present method and system operates herewith.

The method and system can therefore allow submission of the predicted intent to the computer engine, where the predicted intent is formulated into an engine-specific prompt. The method and system can further receive engine output, supplementing the user interactions therewith.

Herein, the method and system provides a dynamic prompt engineering system using user engagement information captured within a background of normal operations. The method and system operates in a background functionality for predicting intent, and then interacts with the user for accessing computer engines using the engineered prompts.

The method and system herein makes computer engine access, such as AI engine access, available to a significantly broader scope of users by not limiting engine effectiveness on the ability to craft a prompt. Instead, the method and system uses background capture to generate suggested prompts, facilitating direct access to these engines.

### BRIEF DESCRIPTION OF THE DRAWINGS

FIG. 1 illustrates a block diagram a processing device for electronically tracking user activity and generating engine prompts;

FIG. 2 illustrates a block diagram of a processing system included various engines receptive to the engine prompts as generated in FIG. 1;

FIG. 3 illustrates one embodiment an architectural structure of the local processing device;

FIG. 4 illustrates a general representation of processing layers;

FIG. 5 illustrates one exemplary embodiment of a capture architecture;

FIG. 6 illustrates a flowchart of the steps of one embodiment of method for generating an engine prompt;

FIG. 7A illustrates operational structures for query processing using vectors;

FIG. 7B illustrates one embodiment of operational structure for

context generation using vectors;

FIG. 8 illustrates a flowchart of the steps on one embodiment of content capture;

FIG. 9 illustrates a flow diagram on one embodiment of content capture;

FIG. 10-12 illustrate sample screenshots of prompt generation embodiments; and

FIG. 13 illustrates an operational flow diagram.

A better understanding of the disclosed technology will be obtained from the following detailed description of the preferred embodiments taken in conjunction with the drawings and the attached claims.

### DETAILED DESCRIPTION

The computerized method and system allows for greater access to computer engines by dynamically generating prompts based on captured user interaction data.

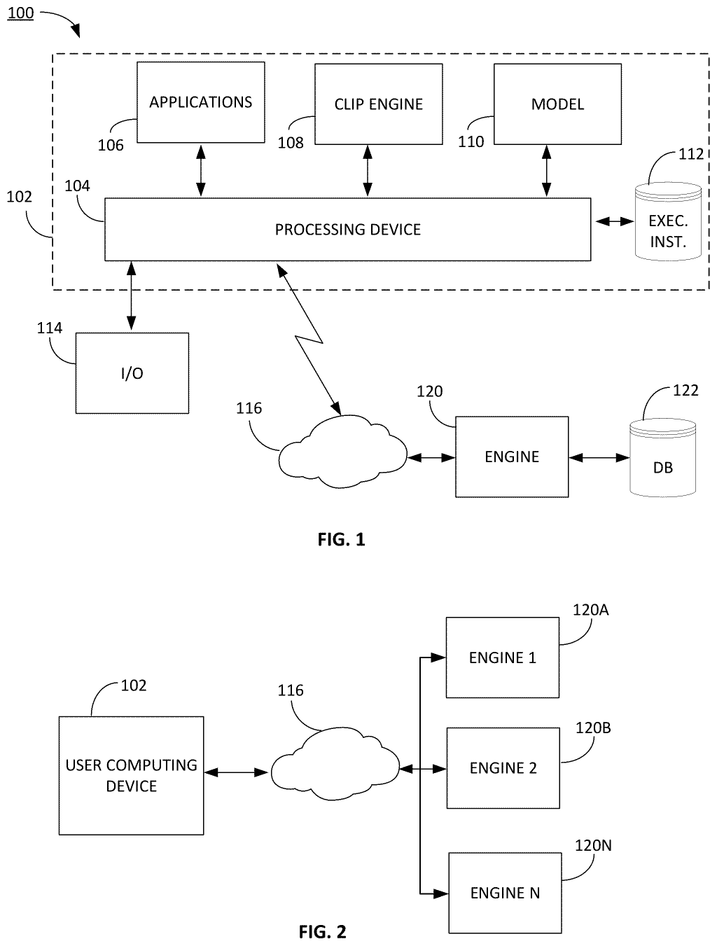

FIG. 1 illustrates one embodiment of a processing system 100 including a local computing device 102. The computing device 102 includes a processing device 104, applications 106, a clip engine 108 or other system for capturing user interactions, a local large language model 110, and executable instructions 112 stored in a computer readable medium. The device 102 further includes input/output elements 114.

The computing device 102 additionally communicates via a network 116 to an engine 120, the engine 120 including at least one database 122 associated therewith.

The computing device 102 may be any local computing device having processing functionality for performing operations as noted herein. For example, the device 102 can be a laptop computer, a desktop computer, a tablet computer, a smart phone, or any other suitable device as recognized by a skilled artisan.

The processing device 104 can be one or more processing elements for performing executable instructions 112. The processing device 104 can be single processing unit (e.g. a CPU) or can be a distributed processing system, for example integrating CPU and graphical processing unit (GPU) functionality.

The applications 106 can be any suitable executable application running on the processing device 104 or within another application running on the processing device 104. For example, the application can be a native executable running at the system level. For example, the application can be an application program interface (API) operating within or with a browser application. For example, the application can be an executable within a chromium or other browser-based environment.

The clip engine 108, as described in greater detail below, provides for dynamically capturing user interaction content. This captured content can be stored within one or more memory locations for processing operations as noted herein.

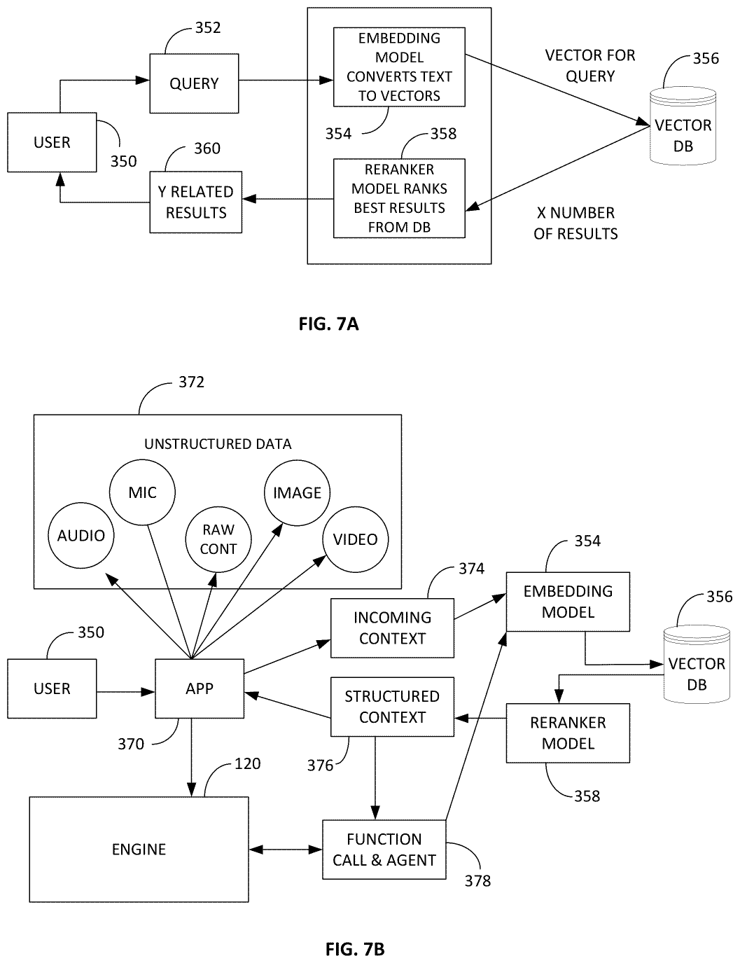

The model 110 can be a local large language model or any other suitable model usable for machine learning, artificial intelligence, or another advanced processing operations as recognized by a skilled artisan. In one embodiment, the model 110 may be a Mistral 8x7B LLM available from Mistal AI. In another embodiment, the model 110 may include embedded models that are representations of value or objects, as described in relation to FIG. 7 below.

The input/output 114 can be any number of user interfacing elements as recognized by a skilled artisan. Input elements can include camera, keyboard, mouse, touchpad, touchscreen, microphone, by way of non-limited examples. Output elements can include display screens, touchscreens, speakers, printers, by way of non-limiting examples.

The network 116 can be any public or private network. In one embodiment, the network 116 is the Internet for allowing data sharing thereacross using known protocols. In further embodiments, the network 116 may include gateway(s) or intermediate processing elements not expressly illustrated. For example, a user on a laptop computer may access the network 116 via a wireless local-area-network and a router, or via a mobile or cellular network accessing the router. A user on a desktop computer can be connected to the router via a hardwired local area network, by way of example.

The engine 120 can be any type of computer engine receiving a user input and generating an output in response thereto. The engine 120 can include database(s) 122 for storing engine data therein. In one embodiment, the engine can be an Al engine or other type of engine using machine learning or other iterative processing operations. In another embodiment, the engine may be a web location or set of locations for accessing specific data. In another embodiment, the engine may be a productivity application, a calendar application, or other task-related operating environment.

The engine, as used herein, can be any suitable processing device or devices, local and/or network-based for improving or enhancing productivity and/or usability of computing resources. The above examples of an Al engine, applications, web engines are exemplary and not limiting examples of the types of engines accessible and usable using the prompt generation input techniques noted herewith.

Where FIG. 1 illustrates the device 102 in communication with engine 120, FIG. 2 illustrates that the device 102 can interact or engage in any number of engines 120A-120N, where N is any suitable integer. These interactions can be via the network 116. In another embodiment, one or more of the engines may be local to the computing device, for example if the engine includes a calendar application for scheduling a task or a reminder, this calendar application can be a local calendar but could also be a network-based calendar system.

The processing operations herein execute within any number of computing environments, including but not limited to mobile and desktop environments. For example, operations on an Android® platform may include varying functions for content capture and tracking versus an Apple® iOS platform, a Windows® platform, a Linux operating platform. In further examples, functionality may be performed via processing operations running in a browser-based environment such as by way of example a Chromium environment.

Moreover, functions and executables can be integrated into an overall processing system. For example, specific functions noted herein can be contained in separate applications (Apps) or executables and communicate with other applications for an overall system operation.

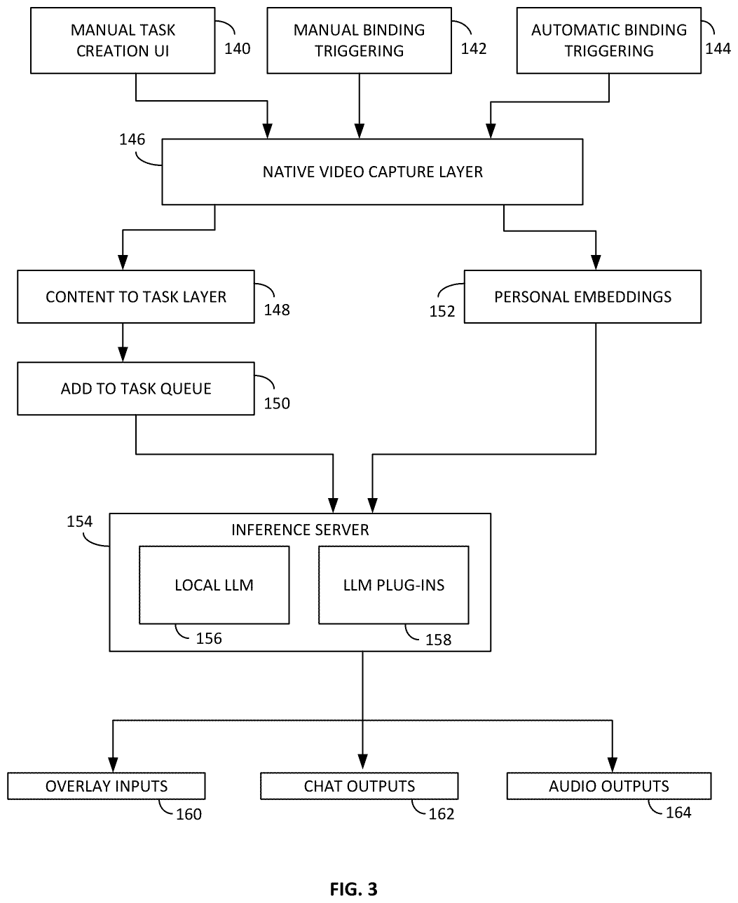

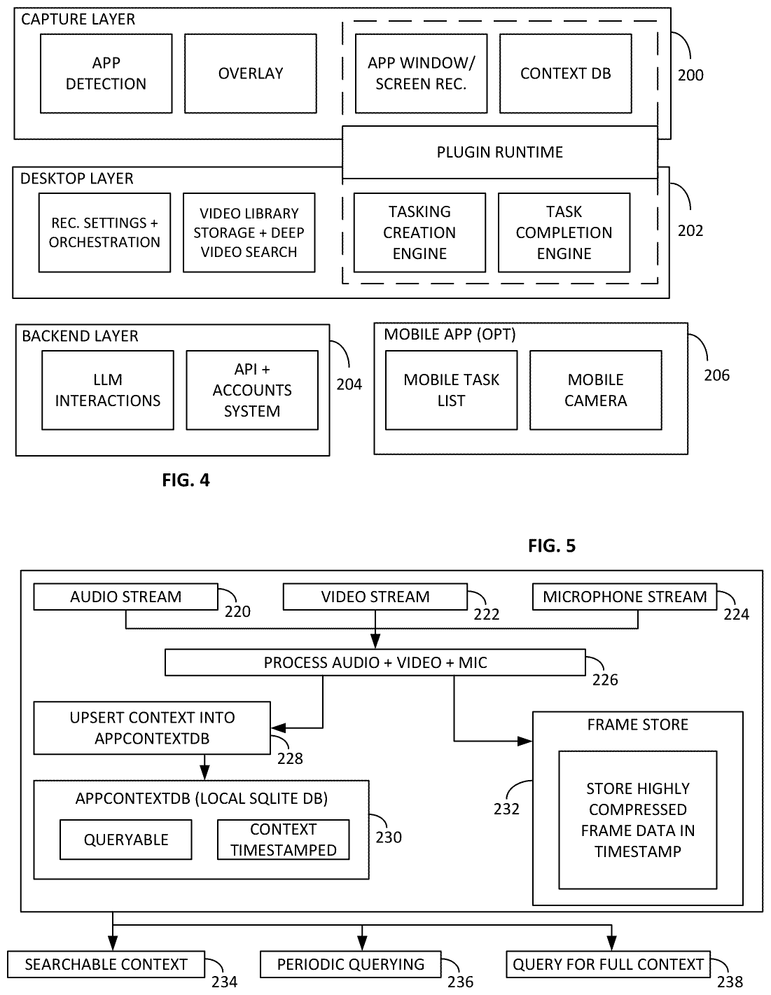

FIG. 3 illustrates one embodiment of a processing environment within processing device 104. This represents, in one embodiment, a local user computer and processing interactions. Boxes represent functionality and processing operations, typically performed using executable instructions running on one or more processing devices, and/or accessing additional data repositories or functional modules.

The processing architecture includes three possible functions: manual task creation 140, manual binding triggering 142, and automatic binding triggering 144. A task is a general term for one type of prompt or related instruction. For example, a task can be a reminder presented to the user, submitted or processed by a third party application, an inquiry for generating an engine prompt, or any other type of data processing element. A binding, similar to a task, is a general term for a data connection or correlation, such as between different applications, data sets, etc.

A manual task creation 140 can include software for generating an interface or other processing element for interacting with the user to create the task. The binding triggering is a processing function for correlating or connecting elements, manual binding triggering 142 being a user-generated binding or automatic binding triggering 144 being a dynamic or auto-generated function.

Upon any of the operations 140, 142, 144, the processing system interacts with the native video capture layer 146. As described in greater detail below, the video capture layer includes processing operations and routines for capturing the user interactivity.

The processing architecture can flow to a content task layer 148. This layer 148 includes frame, audio, and related input processing operations.

Operations 150 is to add to the task queue 150. The queue can be a data structure storing task data representing characterizations of processing operation(s) 148, as well as the task/binding processed prior thereto.

In a further processing routine, the output of the native video capture layer 146 includes accessing a personal embeddings database 152. This operation may include extraction personalization tags to pass in as context. For example, personalization tags can include contextual information such as noting the user activities when the task was generated, e.g. task generated from the browser while visiting URL.

The architecture includes one or more inference servers 154. One embodiment includes a local LLM 156. In a further embodiment, the LLM does not expressly need to me a local LLM but can also use a network-based or network-accessible LLM. One embodiment includes LLM runtime plug-ins 158. For example, plug-ins can include browse functions, software application access, etc.

Where FIG. 3 illustrates the local LLM 156, further embodiments may use network or server based LLM. Varying embodiments can include utilizing the local LLM, a network LLM, a proprietary third-party LLM, a client-specific or user-specific LLM, a combination of local and network-based LLMs or any other suitable combinations as recognized by a skilled artisan.

In this embodiment, the task type to model conversion happens at the inference server. This conversion translates the incoming data into a proposed or estimated response for the user.

The architecture therein provides usability and functionality for the generated inferences. Operations 160 include generating the outputting via overlay outputs. Operations 162 include chat outputs. Operations 164 include audio outputs. Therefore, via various output operations, the method and system interacts to provide feedback to the user as part of the inference and prompt generating functions.

In one embodiment, plug-ins and/or other personalization functions can be included. Generally, the present method and system uses four types of plugins.

A first type is an application binding. This plugin can run at the operating system level detect when an application has started or stopped. For example, if the applicating binding detects a videoconference application is launched or terminated, the application can bind a function to summarize the videoconference. One type of binding is a selection binding, these are bindings that trigger when the user highlights something with his or her mouse inside an application, by way of example if the user highlighted software code.

A second type of binding is a computer vision binding. These bindings can be triggers inside an application that are triggered by computer vision detection of an object type in a frame. For example, an application to automatically detect if an image displayed on the user device is Al generated or a for example a pair of smart glasses detecting a bus stop and overlaying information about when the bus is scheduled to arrive.

Another type of plugin can be a global key binding. This operates similar to an application binding, but it is automatically triggered. A user may activate the binding, for example an instruction to check if news on a computer screen is validated or has been debunked.

Another type of plugin can be a LLM binding. These can run at the LLM level, such as when detecting a particular type of task is found, executing a related or unrelated function. For example, if a task is of a selected type, a related function may be conducting a Reddit® search and then resume generation.

Another type of plugin can be an audio or sound binding. For example, this may be triggered based on a user speaking an audio command.

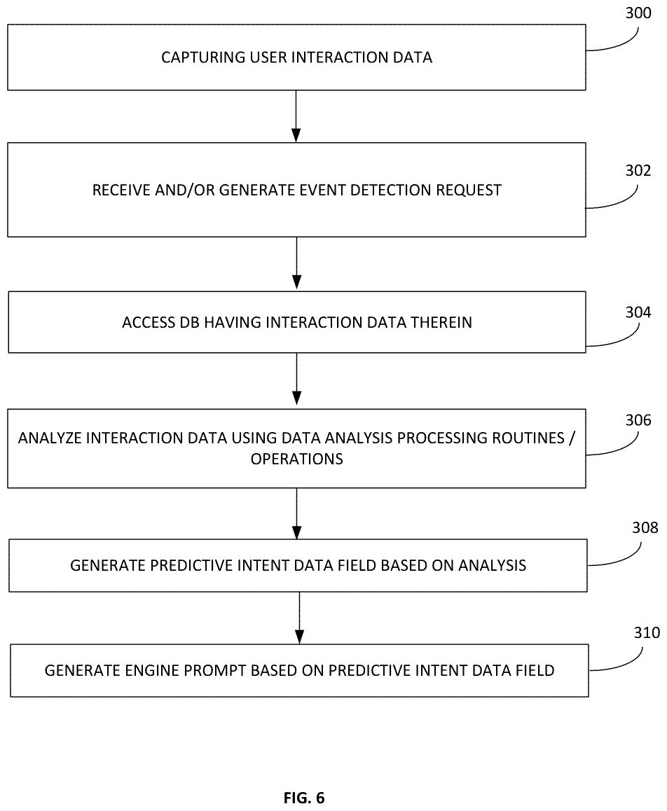

FIG. 4 illustrates one embodiment of a processing computing architecture. This embodiment includes 3 layers, a capture layer 200, a desktop layer 202, and a backend layer 204.

The capture layer 200 includes an app detection module and an overlay module. Further functionality can be found with app window/screen recording module(s) and a context database function.

The desktop layer 202 can include recording settings and orchestration module, as well as a video library, storage management, deep video search module. Further plugins can include a tasking creation engine with context extraction and intent entry, as well as task completion engine, including a chat window and browser environment.

Varying embodiments can generate context and intent memories associated with varying time periods. As described in greater detail below, one embodiment can include an intent memory associated with a short prior-in-time duration ranging between several minutes to up to an hour or so. This intent memory can capture a specific intent of the user based on recent activities. By contrast, another embodiment of memory can be context memory having a much broader scope of time, for example longer than the intent memory up to several days, weeks, etc. This context memory provides a broader context association of user activities versus a time-specific intent.

In varying embodiments, plugin modules can operate alongside native applications or in the browser task completion environment.

A backend layer 204 includes customer real-time LLM interactions, as well as API and Account system access. These applications allow for proprietary or customized language models, as well as secure access to third-party software and/or services.

In one embodiment, a mobile application layer 206 can be optionally included. This can include a mobile task list, as well as a mobile camera and/or other input devices.

Where FIG. 4 illustrates one embodiment of a processing architecture, FIG. 5 illustrates one embodiment of a capture architecture. The capture architecture allows for capturing local processing details and therein assessing or determining a predicted intent using LLM functionality.

In this embodiment, the capture architecture notes three sample incoming streams, an audio stream 220, a video stream 222, and a microphone stream 224. It is recognized additional streams can be within the scope of the architecture and the listed examples are not expressly limiting.

A processing routine 226 processes the incoming streams. Upon task creation, termination of session, or any other suitable triggering event, a processing routine can upsert context into AppContext Database 228. The AppContextDB 230 can be a local database that can include accessibility via query logic, such as a local SQLite DB. The database can be queryable, for example selecting content from a defined prior time period, for example selecting content from an application or set of applications, or any other suitable query or scope as recognized by a skilled artisan. The database can further include context timestamps associated with the data, providing for query access and including time as a conditional factor.

In another embodiment, the processing module 216 of the input streams can store the data into a frame store 232. Herein, the frames are stored in a highly compressed frame data with a time stamp.

In varying embodiments, the capture architecture of FIG. 5 can generate different output types. A first type is a searchable context 234. A second type is a periodic querying for personalized embeddings 236. A third type is query for full context when a task is created or executed via a new clip 238.

FIG. 6 illustrates a flowchart of the steps of one embodiment of a method for generating predictive intent. Step 300 is capturing user interaction. This can be captured using architecture and processing operations noted above, as well as content capture operations described below.

Step 302 is receiving and/or generating an event detection request. This request can be an automated event, for example upon detecting the launching or closing of an application, performance of a function within an application, etc. For example, if the system detects a videoconference application is closed, an event detection request can be to summarize a prior videoconference. Similarly, if the application itself executes an end call function but the application is not closed, an event detection request can be triggered. Other examples can include a user manually generating an event detection request, for example selecting a request command, a hotkey selection, or any other suitable engagement or launch operation.

Step 304 is accessing a database having interaction data stored therein. For example, native capture layer 146 of FIG. 2 can include storage of the interaction data. For example, the frame store 232 of FIG. 5 can further represent embodiments of this interaction data being stored and accessible for further processing operations.

Step 306 is analyzing the interaction data using data analysis processing routines and operations. Step 308 is generating a predictive intent data field based on this analysis. These operations can be performed using the LLM associated with the user and the processing system. For example, these processing operations can be performed using the inference server 154 of FIG. 2.

Steps 306 and 308 include recognition of the captured content, for example using speech recognition to detect keywords in the audio content, for example using computer vision to recognizing visual elements on a captured frame of images, for example using original content recognition to recognized words using in images, etc.

The predictive intent data field is the estimated output of the LLM based on the analysis of the captured content. This predictive intent data field can be generated based on recognition of relationships between user interaction data elements, including the LLM hosting data sets of relationships. The volume of relationships within the LLM can relate to the accuracy of the predictive intent. Wherein further embodiments can include iterative or feedback elements allowing the LLM to additionally learn and improve the accuracy of its predictive intent data generation operations.

Step 310 is generating an engine prompt based on the predictive intent data field. As used herein, a prompt can be any number of operations relating to further engine engagement. For example, one type of prompt can be an instruction prompt for a computer engine, for example an Al engine. For example, one type of prompt can be a task or execution for performance by one or more applications, for example setting a calendar reminder.

In further embodiments, the generation of the prompt can include generating a variety of prompts for different engines. For example, a pop-up window can generate separate prompts for each different type of engine. In one example, if the user was watching a cooking video, having a videocall with a friend discussing a dinner party, and was doing an Internet search for cooking ingredients, this interaction data could lead to a variety of prompts for different engines. A first prompt could be an Al engine prompt for seeking dinner meal ideas. A second prompt could be a calendar engine prompt to generate a calendar invite to include friends. A third prompt could be a shopping list application or online food/grocery ordering prompt to generate a shopping list. A fourth prompt could be an Al engine prompt requesting recommendations for wines or other drinks to accompany an estimated type of meal.

Herein, the user can be presented with the prompt options and associated engines. The user could select one or more of the prompts and engage the engine(s). The user could modify the prompt. Thereby the user thus is presented with predictive intent prompts associated with a plurality of engines based on the system dynamically tracking and reviewing content capture of prior user experiences.

FIG. 7A illustrates one embodiment of a processing architecture accounting for vector embedding models associated with context data. As user herein, a vector embedding model is a representation of values or object, for example such as text, images, audio, designed for consumption by machine learning models, semantic search algorithms, and other types of engines. For example, audio data is translated using an audio model having a plurality of model points or values. This model is then transformable into an audio vector embedding, which in one embodiment can be a multi-value strong of data values representing a translation or transformation of the audio model. Similar examples can be found with text converted to text models and then text vector embeddings, as well as videos into video models and then video vector embeddings.

In this processing architecture of FIG. 7A, a user 350 engages the computing system to generate a query 352, for example consistent with a query as noted above. Via processing operations, operations 354 provide for using embedding models to convert text to vectors. Where this example uses text models, the same processing can apply to audio and/or video.

The vector generated therewith is usable for the query, via the vector database 356. The vector database 356 can be one or more suitable data storage device(s) can vector data stored therein. The vector database 356 accepts incoming vector space data and performs a series of k-nearest neighbor searches to identify relevant vectors within its database.

Using search functions, a number of results are extracted from the database 356. Where FIG. 7A lists X as a number of results, X can be any suitable integer, for example one embodiment generating 50 results.

Processing operation step 358 is to rank the best results from the database. In one embodiment, a reranker model performs iterative processing operations to further refine the results by adjusting the order of the results, placing results with a higher probability of being applicable higher in a ranked order. The reranker model can perform adjustments of the rankings based on a statistical modelling, including accounting for prior search or other prompt actions, as well as accounting for context data.

Based on the ranking in 358, a top number of related results, 360, are provided back to the user 350. For example, in one embodiment, the results are presented via user interface options as illustrated below.

FIG. 7B illustrates another operational structure for using data vector embeddings with engine operations. Here, the user 350 operates an application 370, which can be any suitable type of application running on a computing device. Moreover, the interactions can be with any number of applications, for example applications running background or second screen, such as a video conference application, a slide presentation application, and a messaging application.

The application(s) 370 generate unstructured data 372. This illustrates 5 sample types of unstructured data, audio, microphone data, raw context data, image data, and video data.

The application 370 can include a call or inquiry to an engine 120. Herein, the application 370 can submit the call or inquiry using the predicted intent via the user interface noted herein. For example, the application 370 operates similar to the operations of FIG. 7A above, with an incoming context field 374 being transformed into the embedded vector model 354 and basis for accessing the vector database 356 and the results refined by the reranker model. This generates structured context, usable for the app 370 call to the engine 120.

In a further embodiment, the application 370 can also include additional refinements or data points to the call or inquiry based on a function and call agent 378 operating in response to the engine 120. In this embodiment, the engine 120 may generate a function call to processing module performing functional call and processing agent 378.

This processing module 378 knows the inquiry or prompt submitted to the engine 120 and can further refine the engine operations via back-end engagement of the vector embedding model 354. In this embodiment, the back-end processing includes automated operations performed outside of the direct instructions or control of the user 350.

Using a similar processing routine as FIG. 7A, the conversion of text to vector in module 354 allows vector retrieval from the database 356 and refinement of the vector results via the model 358. The structured context module 376 further imparts the user engagement context to the vector results and the results are then presented by to the function call and agent 378. Here, the agent 378 can then provide this additional information, context, to the engine 120. This gives the engine a broader context and more information for the prior inquiry, allowing the engine to generate a more accurate result. And here, the accuracy of the engine results are improved based on the predicted intent of the application 370 and the context via the vector database 356.

The application 370 can further generate an incoming context data field 372 capable of being provided to the model 354, similar to FIG. 7A above. Via the vector database 356 and the reranker model 358, structured context 374 is generated therefrom.

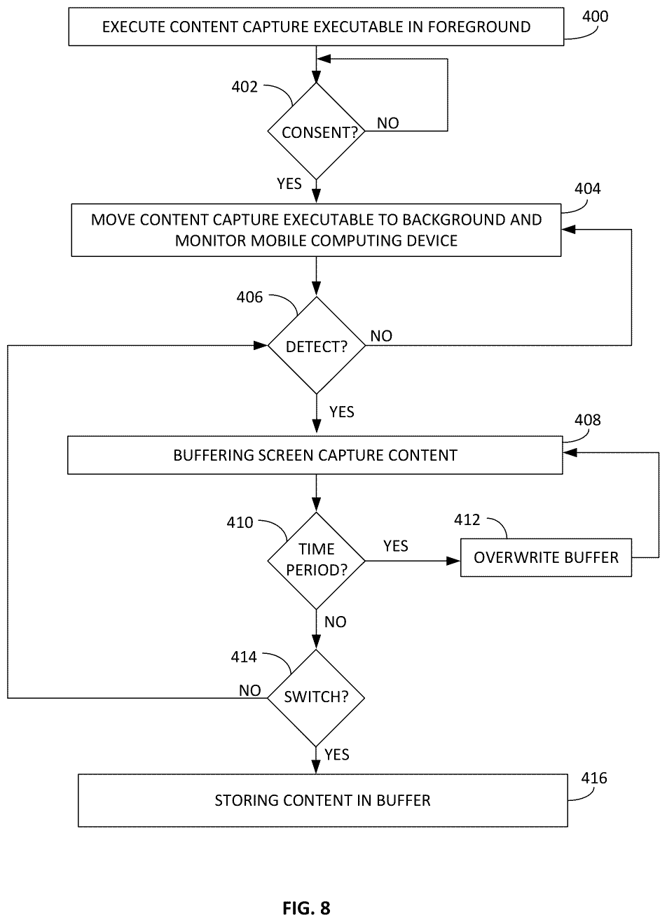

More specific to the computerized method and system, FIG. 8 illustrates a flowchart of the steps of an exemplary embodiment content capture. Step 400 is to execute a content capture executable in a foreground execution.

Here, foreground execution is directing the application to execute for direct user input and output. The foreground execution of an application is the application to which the user actively engages. By contrast, the computer system can operate applications in a background execution, which includes continuing to perform processing operations but not directly engaging the user for input and output functions.

While operating in the foreground, the content capture executable can include any number of functions or features, such as a user account login, setting preferences, or other features. Because of security and platform restrictions, the user may be required to give consent for screen or content capturing on the mobile device. The content capture executable 400 requests user consent for capturing content. This may be via a pop-up window or other user interface.

Step 402 is detecting if the user grants consent. If no, the method reverts until granted. Once granted, the method proceeds. In further embodiments permission may not be expressly requested or required can be omitted.

Step 404 is moving the content capture executable to background execution and monitoring the mobile computing device. Here, the executable continues to perform processing operations, but omitting direct interfacing with the user. The monitoring of the processing operations of the mobile computing device can include any number of techniques, including for example tracking the amount of computing power and memory requirements actively being used by the computing device.

The computing method and system may include additional techniques for content capture in varying embodiments. For example, one technique may include a voice command from the user. This technique may utilize a voice recognition engine associated with the mobile device. Another technique may be a hotkey combination with the mobile device. For example, common techniques include double-tapping a home button for electronic payment, depressing the home button and a side button for a screen capture. A hotkey selection can be made available via the mobile operating system to enable game recordation without disrupting current gameplay, e.g. requiring the user to switch active foreground application(s) to then manually turn on recording functions.

Once the content capture executable is in the background, the mobile device executes other applications in the foreground.

The user, engaging the computing device, executes an application in the foreground. Meanwhile, the content capture executable monitors via background execution. Therefore, step 406 is if engagement with one or more executable applications is detected.

Step 406 can include additional steps beyond the monitoring, including verifying the application is an acceptable application for screen capture.

Additionally, even if monitoring detects activity, the application being played may not be suitable for clip detection and distribution. Therefore, one embodiment includes determining an application identifier representing the application being executed in the foreground position. This application identifier is a universal identifier assigned to the application as part of mobile device application (app) distribution via a centralized operating system store. Therefore, detection may include referencing the application identifier against a table with a reference list of acceptable executables. The reference list can be generated directly from the operating system store or via any other suitable source.

In step 406, if the application is not an acceptable application, recordation of content capture can be prohibited. The method reverts back to step 404 to continue monitoring.

Step 408 is buffering screen capture content. The content capture executable continues executing in the background, allowing the user to maintain engagement with the executing application. The content capture executable captures screen content without disrupting or interrupting the user engagement.

Buffering of screen content capture can have specific limitations with storage capacities. Therefore, step 410 is determining a time period for content capture. This time period, which may be defined by the user or can be defined by calculating available memory resources, avoids unnecessarily filling up all available memory on the mobile device.

In one embodiment, the memory device can be a circular buffer. After a defined time period, step 412 includes overwriting prior buffered content. For example, the time period may be for a period of 60 seconds with overwriting occurring after this 60 seconds.

The method and system, with dynamic buffering, allows for capturing content that has previously occurred.

The method detects if the user switches applications, step 414. If no, the method continues to detect content and buffer. Herein, the content capture can capture content agnostic to the specific application, but instead capturing content from a system-level perspective of general user interactions.

Step 416 is storing the content capture data. This data can then be usable for processing operations as noted above.

The computing method and system can additionally account for capturing audio. The audio may be application audio, user generated audio, or a combination of both. When accounting for storage limitations, the video content is not stored on a frame-by-frame basis, instead using key frames with accounting for inter-frame video differences. Thus, the method and system stores audio in a separate file apart from the video. The audio is captured using audio capture recording techniques to write the audio content into a buffer. The nature of audio recording uses significantly less storage space, thus limitations associated with video storage are not found in the audio storage process.

In one embodiment, the audio is captured using a timestamp or other tracking feature. The audio being separately stored is then later merged back with the video feed for content distribution. This merging is synchronized based on the timestamp.

Where the video content can be stored using key frames, further modification of the audio file may be required. For example, if the recorded audio segment aligns outside of a key frame, the audio may be asynchronous. Therefore, further adjustment of the audio file may account for dropping audio content prior to a starting video key frame, ensuring synchronicity between audio and video.

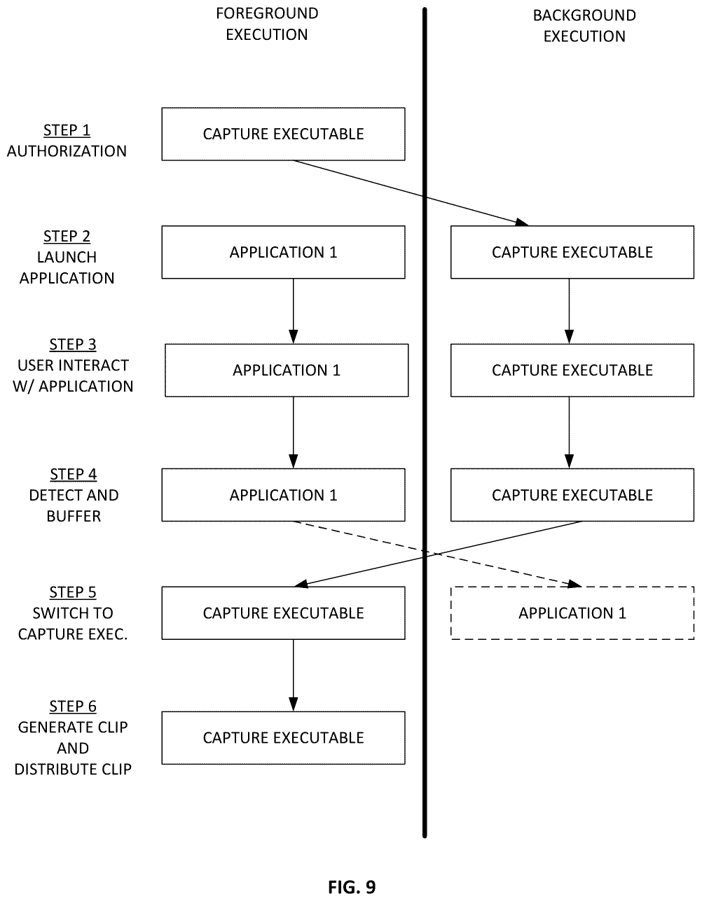

FIG. 9 illustrates a sequential diagram showing execution of various executables in the different positions.

In step 1, the capture executable executes in the foreground position. This first step is the authorization step where a user authorizes content capture in the mobile device. Authorization satisfies security restriction and requirements in the mobile computing platform based on capturing screen content of other executables.

In step 2, the user can then launch a first application. The mobile operating system executes the first application in the foreground position, the capture executable in then moved to background execution. In this background execution, the capture executable continues performing processing operations.

In step 3, the user interacts with the first application, which continues to execute in the foreground position. In one example, if the application is a videogame, the user can be playing the videogame on the mobile computing device. The capture executable still executes in the background, including monitoring execution of the first application.

In step 4, the user continues to interact with the first application still in the foreground position. This could include the user continuing to play the videogame (first application). The capture executable executes in the background to detect and buffer content consistent with techniques described herein.

In step 5, the user either discontinues playing the videogame (first application) or can manually swap the foreground and background execution. In one example, the user may select a home button displaying screenshots of active applications running in the background, scroll through the thumbnails and select the capture executable to move it to the foreground position. In another embodiment, the user can return to a home screen and select an application thumbnail.

In step 5, the user switches to the capture executable, moving the capture executable to the foreground position. If the user is simply swapping positions, the first application can continue to execute in the background position, typically idle awaiting user input. If the user terminates the first application, the application is closed and no longer executes.

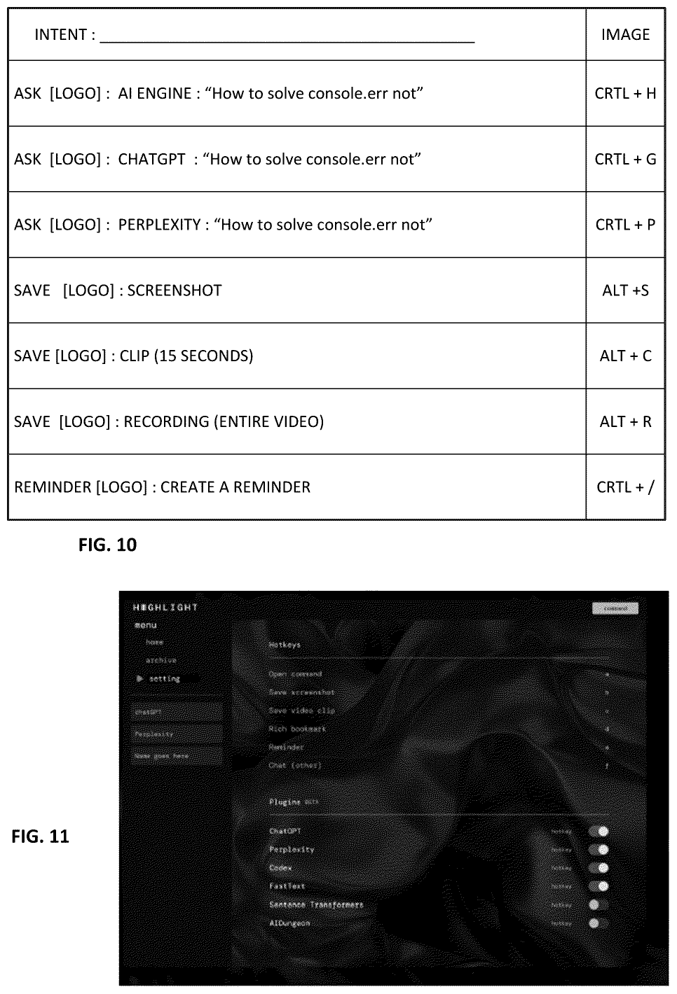

In step 6, the user generates the clip and distributes the clip. This step is performed via the capture executable, which continues to run in the foreground position.

Where the above processing techniques provide for task generation using background content capture techniques, FIG. 10 illustrates one exemplary embodiment of a display screen presenting to the user a plurality of suggested tasks. These tasks are generated by the LLM created a predicted intent and translating the intent into a task associated with a corresponding engine. In this example, there are three different artificial intelligence engines, three functional operations, and an application execution task.

Further visible in the task window is a general intent field at the top. The general intent may be a statement of the general context is estimated by the processing operations. For example, if the user has been drafting software code and receiving an error message of “console.err not,” the intent can be a recognition that the user is having problems with software drafting and the associated error code.

In this example, the user can be presented with 7 possible task executions and associated hotkeys for performing the tasks. The first three examples can be asking an artificial intelligence engine or other machine learning engine “how to solve consolve.err not” error code. An executable operation can include operating system functions, such as a capturing a screenshot, generating a video clip of prior user interactions, and recording a full video of prior engagements. An example of an application task can be generating a calendar reminder, for example reminder to contact an assistant to help with the error code.

In varying embodiments, the user can revise the intent and this then can change the task.

In user control functions, the user or system operator can further manage available tasks and associated engines. For example, FIG. 11 is a screenshot of a management screen for with tabbed screens for multiple engines. Within the multiple tabs may include multiple predicted intent fields, allowing for user selection or modification.

In one embodiment the user may be presented with notification or information relating to content capture. In another embodiment, content capture may be entirely in the background, with the user being unaware or at least not being actively involved or notified of the content capture. FIG. 11 illustrates an embodiment of the display of the search bar or other user interface with the suggested intents and associated engines.

As visible in FIG. 11, a secondary window notes an audio transcript. Therefore further generation of the predicted intent can be based on audio itself or may use text of a transcript from the captured audio. The audio and/or transcript can be part of the prompt, not only for prompt generation, but also as part of the embedded prompt and information provided to the associated engine.

In further embodiments, the method includes applications available for integration into the computing system. Integration improves functionality and interoperations, see for example application 370 of FIG. 7B above.

FIG. 12 illustrates a sample screenshot of a search bar and associated applications, which can be models, extensions, websites by way of example. Via the user interface, the user can search and select one or more applications for further integration into the computing system described herein.

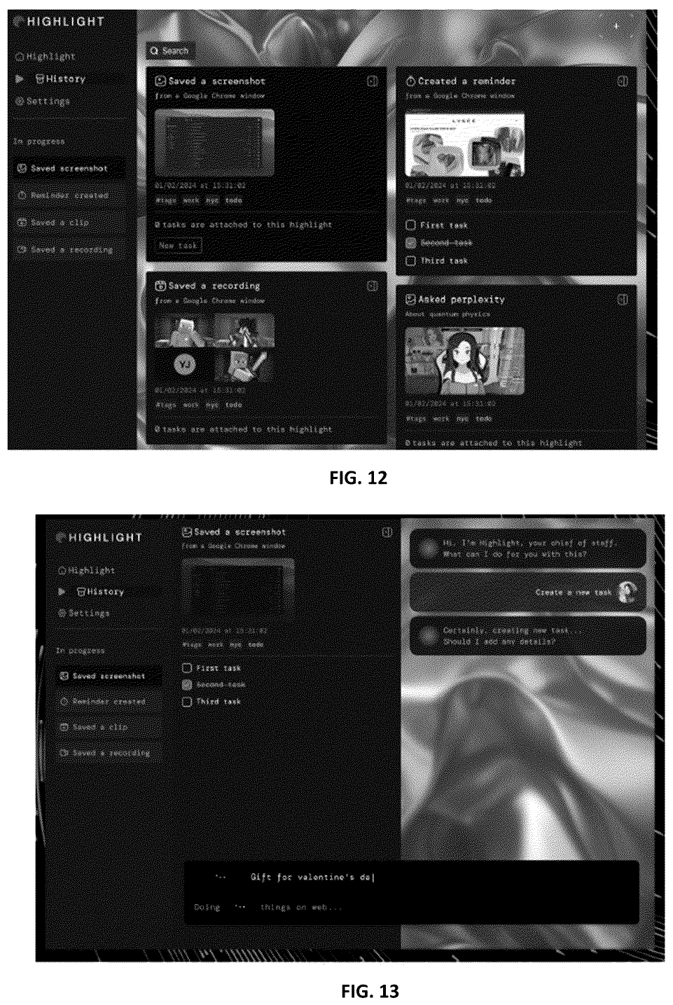

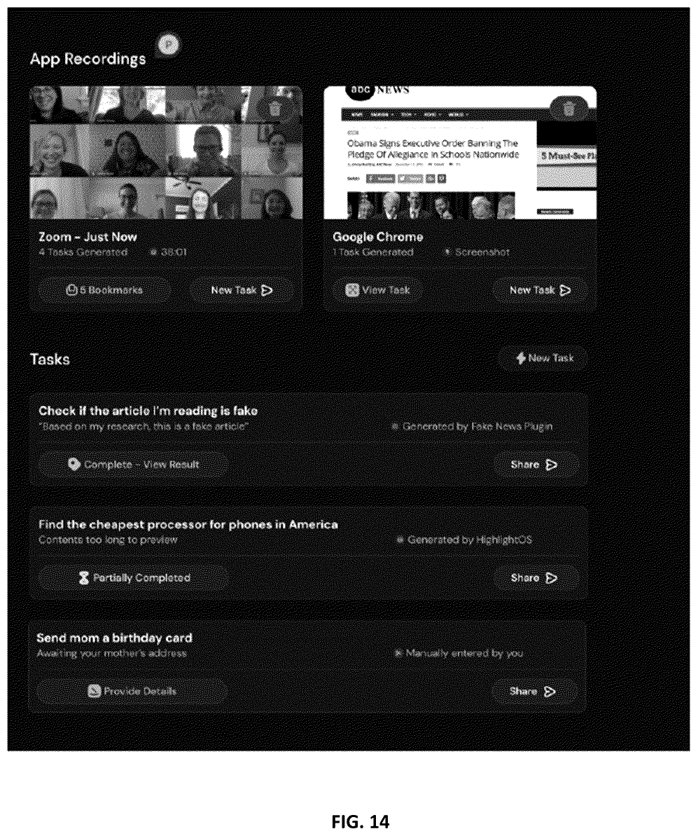

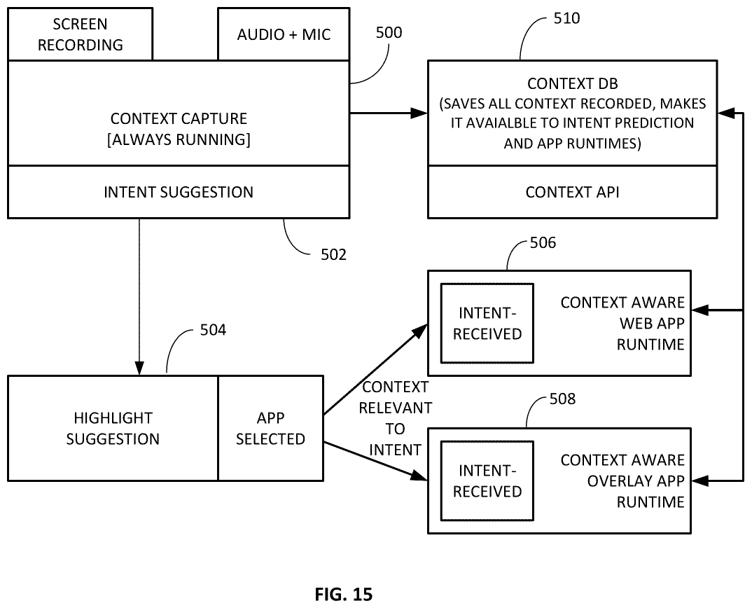

FIG. 13 illustrates one embodiment of a processing flow diagram for context capture and intent suggestion. Block 500 represents a context capture executable, which can be an actively running application in a background position. As noted in FIG. 13, the application 500 can include screen recording, audio and microphone capture executables, as well as any other suitable data and/or i/o capture operations.

The operations of element 500 include differentiation of context versus intent, as noted above. The context refers to a longer time horizon of data capture, for example multiple days, weeks, etc. The intent refers to a more concise time horizon, for example measured in multiple minutes typically not exceeding an hour. The difference in context versus intent is found both in data capture and storage, as well as usage of the information for improving engine engagements.

In one embodiment, the user operating a computing device can activate an intent suggestion operation 502 by selecting a keystroke or other engagement means. The intent suggestion, in one embodiment, takes all context information and generates a predicted intent suggestion. This can be a data field or data structure. In further embodiments, the intent suggestion can be refined or tailored relative to concurrently executable applications and/or available engines.

Step 504 is a highlight selection executable. In one embodiment, this may be a user interface window presenting the user with multiple intent suggestions associated with different applications. See, for example, FIG. 10 listing multiple prompts for different engines generated and based on the predicted intent.

The selected app in box 504 can represent the user selecting a particular engine. For example using FIG. 10 as a reference, the user may select CTRL+G and thus engage the Al engine ChatGPT with the inquiry of “how to solve console.err not.” In this example, application 506 can be block 506 being a context aware web application runtime, including operations based on the intent received data structure. In another example, application 508 may be a context aware overlay application runtime, for example the application Perplexity running based on the context relative to intent and intent received data structure.

In further embodiments, the processing environment may include further processing using context capture from operation block 500. The context capture information can be stored in a context database 510. This database 510 stores all context recorded via the context capture 500 and makes it available to intent prediction and application runtimes. Therefore, FIG. 13 further notes communication and data sharing functionality between the context database 510 and the runtime executables 506, 508.

The predicted intent and generating an inference request can require extra processing capabilities, for capturing contextual information, as well as burdens on storage requirements. Therefore, varying embodiments can include local storage and execution, if resources are available, and/or network and/or cloud-based. One embodiment may include a load balancing operation to determine the local processing abilities, as well as network load. One embodiment may include a cost service available with different load options.

In a local route, all operations can be performed at the local device. This offers the most secure and can include limiting or preventing interference requests at high graphic processing unit (GPU) output times, e.g. if the user is playing a video game.

In a network route, operations can be performed within a set of networked servers. This can include routing the inference request via a realtime proxy to a local participating network processing unit. This can include reading streamed responses back from a peer to peer network.

In a cloud route, operations can be channeled to a dedicated cloud-based processing system. For example, this may include a subscription service for offsetting server costs, but in return providing higher degrees of information security and improved response time based on available computing resources. This can include reading streamed responses back from the cloud server.

FIGS. 1 through 13 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. As used herein, executable operations and executable instructions can be performed based on transmission to one or more processing devices via storage in a non-transitory computer readable medium.

What is claimed is:

1. A computerized method comprising:
capturing user engagement with a computing device and storing user interaction data based on the capturing of the user engagement;
accessing at least one data storage device having the user interaction data associated with the computing device;
analyzing the user interaction data and generating a user context therefrom; and
generating a predicted intent within a user display interface, the predicted intent generated from the user context.

2. The computerized method of claim 1 further comprising:
using a content capture module to capture the user engagement with the computing device.

3. The computerized method of claim 2, wherein the content capture includes one or more of: audio, video, data, single screen capture, continuous screen capture.

4. The computerized method of claim 1, wherein the generating the predicted intent uses a large language model.

5. The computerized method of claim 1, where in the user interaction data include a plurality of unstructured data, the method further comprising:
converting the unstructured data into vectors; and
storing the vectors in a vector database.

6. The computerized method of claim 5, wherein generating the predicted intent is based at least on vectors retrieved from the vector database.

7. The computerized method of claim 1 further comprising:
receiving a user selection of a predicted intent via the user interface, where the predicted intent is associated with a computing engine; and
wherein the predicted intent is an input prompt for the computing engine, transmitting the input prompt to the computing engine.

8. The computerized method of claim 7, wherein the computing engine is an artificial intelligence engine.

9. The computerized method of claim 7, wherein the computing engine is a utility application.

10. The computerized method of claim 7, wherein the computing engine is a search engine.

11. A computerized method comprising:
accessing at least one data storage device having user interaction data associated with a computing device;
analyzing the user interaction data and generating a user context therefrom;
generating a predicted intent within a user display interface, the predicted intent generated from the user context; and
presenting on the user display interface input for a user to submit the predicted intent to a computing engine.

12. The computerized method of claim 11 further comprising:
receiving an accept input from the user for accepting the predicted intent as presented or receiving an input of a user-modification of the predicted intent and generating a modified intent.

13. The computerized method of claim 12 further comprising:
accessing additional user interaction data from the at least one storage device; and
generating an engine prompt for the computing engine based on the additional user interaction data and the predicted intent or the modified intent.

14. The computerized method of claim 13, wherein the computing engine is an artificial intelligence engine.

15. The computerized method of claim 11, wherein the generating the predicted intent uses a large language model.

16. The computerized method of claim 11, where in the user interaction data include a plurality of unstructured data, the method further comprising:
converting the unstructured data into vectors; and
storing the vectors in a vector database.

17. The computerized method of claim 5, wherein generating the predicted intent as based at least on vectors retrieved from the vector database.

18. A computerized method comprising:
capturing user interaction data including unstructured data;
converting the unstructured data into vectors;
storing the vectors in a vector database;
accessing the vector database and retrieving a plurality of vector results therefrom;
using statistical modeling, ranking the plurality of vectors to determine a first set of result vectors;
generating a predicted intent within a user display interface using at least one of the results vectors from the first set of result vectors; and
presenting on the user display interface input for a user to submit the predicted intent to a computing engine.

19. The computerized method of claim 18, wherein the computing engine is an artificial intelligence engine.

20. The computerized method of claim 18, wherein the unstructured data is text data.
